(19) United States
(12) Patent Application Publication
(10) Pub. No.: US 2007/0050848 A1
(43) Pub. Date: Mar. 1, 2007

(54) Preventing malware from accessing operating system services

(75) Inventor: ATM Shafiqul Khalid, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/218,042

(22) Filed: Aug. 31, 2005

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

Aspects of the present invention are directed at preventing a malware that exploits a vulnerability in an operating system from accessing services provided by the operating system. In one embodiment, a method is provided that determines whether a request directed to an operating system originated from a memory address space that stores data obtained from an untrusted source. In this regard, the method causes the flow of program execution to be interrupted when a request is received by the operating system. Then the memory address space allocated to the calling process that stores data obtained from an untrusted source is identified. If the return address where program execution is scheduled to continue after the request is satisfied refers or points location in memory that stores data obtained from an untrusted source, then the flow of program execution is scheduled to be redirected in a way that is characteristic of malware.

### BACKGROUND

As more and more computers and other computing devices are interconnected through various networks, such as the Internet, computer security has become increasingly more important, particularly from invasions or attacks delivered over a network or over an information stream. As those skilled in the art will recognize, these attacks come in many different forms, including, but certainly not limited to, computer viruses, computer worms, system component replacements, denial of service attacks, even misuse/abuse of legitimate computer system features, all of which exploit one or more computer system vulnerabilities for illegitimate purposes. While those skilled in the art will realize that the various computer attacks are technically distinct from one another, for purposes of the present invention and for simplicity in description, all malicious computer programs will be generally referred to hereinafter as computer malware, or more simply, malware.

When a computer is attacked or “infected” by computer malware, the adverse results are varied, including disabling system devices; erasing or corrupting firmware, applications, or data files; transmitting potentially sensitive data to another location on the network; shutting down the computer; or causing the computer to crash. Yet another pernicious aspect of many, though not all, computer malware is that an infected computer is used to infect other systems.

A traditional defense against computer malware, and particularly computer viruses and worms, is antivirus software. Generally described, antivirus software scans incoming data, looking for identifiable patterns associated with known computer malware. Also, increasingly, antivirus software is utilizing heuristic techniques that compare incoming data with characteristics of known malware. In any event, upon detecting a computer malware, the antivirus software may respond by removing the computer malware from the infected data, quarantining the data, or deleting the infected incoming data. However, as antivirus software has become more sophisticated and efficient at recognizing thousands of known computer malware, so, too, have the computer malware become more sophisticated. For example, malware authors have recognized that antivirus software only performs scans for malware when certain events are scheduled to occur. As a result, malware has been designed to execute malicious functionality without triggering an event that would cause antivirus software to perform a scan.

Those skilled in the art and others will recognize that antivirus software typically performs a scan or other type of analysis for malware when certain events occur. For example, when an application program is scheduled to be executed, program code that implements the application program is loaded from a storage device, such as a hard drive, into system memory that is accessible to a Central Processing Unit (“CPU”). Typically, antivirus software performs a scan when program execution is scheduled to occur or “on-access.” However, a scan for malware may also be performed in other instances. For example, a scan may be performed “on demand” when a user issues a command to scan a volume or other logical unit of data that resides on a storage device. In these examples, data on the storage device is sequentially copied from the storage device into system memory where the CPU executes instructions designed to identify data in memory that is characteristic of malware. Once the antivirus software completes a scan, the data loaded in memory will typically be executed without additional scans by antivirus software being performed. However, in some instances, data in memory may be modified by malware after a scan is performed. For example, a vulnerability in an operating system may allow malware to overwrite data items in memory that direct the flow of program execution. In this instance, the flow of program execution may be directed to instructions associated with malware.

In an exploit commonly known as a buffer overflow, a malware author identifies an existing operation implemented by an operating system that copies data to a buffer in memory. In this type of exploit, a limited segment of memory is allocated to the buffer, and a check to determine whether the allocated area of memory is sufficient to complete an operation is not performed. As a result, the malware causes excess information to overwrite data in memory that dictates the flow of program execution. For example, a return address that identifies a location where program execution should continue after a function call is executed may be overwritten. As a result, an application program or “process” that was initially identified as being safe to execute is corrupted. When a computer malware gains control of a computer using this type of attack, the potential damage to the computer is substantial as the process “hijacked” by the malware may be highly trusted, running with system and/or administrator privileges. As a result, the malware will inherit the same trust level as the process that was corrupted.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The foregoing problems discussed in the Background Section above are overcome by a calling routine integrity checker, embodiments of which are directed at preventing a malware that exploits a vulnerability in an operating system from accessing services provided by the operating system. More specifically, in one embodiment, the calling routine integrity checker performs a method that determines whether a request directed to an operating system originated from a memory address space that stores data obtained from an untrusted source. In this regard, the calling routine integrity checker causes the flow of program execution to be interrupted when certain types of requests are made to the operating system. Then, in one embodiment, the memory address space allocated to the calling process that stores data obtained from an untrusted source is identified. Moreover, the method identifies the return address where program execution is scheduled to continue after the request to the operating system is satisfied. If the return address refers to a location in memory that stores data obtained from an untrusted source, then the flow of program execution is scheduled to be redirected in a way that is characteristic of malware.

In another embodiment, the calling routine integrity checker acts as a software system that prevents a malware which attempts to redirect the scheduled flow in program execution from accessing services of the operating system. More specifically, the software system includes (1) an operating system that, among other things, manages computer resources and performs services on behalf of application programs, (2) an exception handling system operative to identify an exception raising condition and invoke an appropriate exception handler, and (3) a check source exception handler that determines whether a service provided by the operating system obtained input configured to redirect the normal flow of program execution.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary pictorial diagram which illustrates the hierarchical structure that exists between system components of a modem computer;

FIG. 2 is an exemplary block diagram of a computer that illustrates an environment in which aspects of the present invention may be implemented;

FIG. 3 is an exemplary pictorial depiction of a memory address space allocated to a process that may be used to describe the memory management functions performed by an operating system; and

FIG. 4 is an exemplary flow diagram that illustrates a method of determining whether the flow of program execution is scheduled to be redirected in a way that is characteristic of malware.

### DETAILED DESCRIPTION

The calling routine integrity checker may be described in the general context of computer-executable instructions, such as program modules, being executed by a computer. Generally described, program modules include routines, programs, objects, components, data structures, and the like that perform particular tasks or implement particular abstract data types. The calling routine integrity checker described herein may also be practiced in distributed computing environments where tasks are performed by remote processing devices that are linked through a communications network. In a distributed computing environment, program modules may be located in local and/or remote computer storage media.

While the calling routine integrity checker will primarily be described in the context of preventing malware that performs specific types of overflow exploits from accessing services provided by an operating system, those skilled in the relevant art and others will recognize that the calling routine integrity checker is also applicable to other areas than those described. In any event, the following description first provides a general context and system in which the calling routine integrity checker may be implemented. Then a method that implements aspects of the calling routine integrity checker is described. The illustrative examples described herein are not intended to be exhaustive or to limit the invention to the precise forms disclosed. Similarly, any steps described herein may be interchangeable with other steps or combinations of steps in order to achieve the same result.

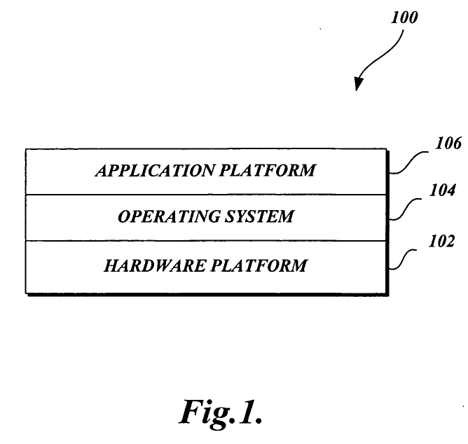

Now with reference to FIG. 1, a computer 100 which maintains a hierarchical structure that is characteristic of modem computers, will be described. The computer 100 illustrated in FIG. 1 may be any one of a variety of devices including, but not limited to, personal computers, server-based computers, personal digital assistants, cellular telephones, other electronic devices having some type of memory, and the like. For ease of illustration and because they are not important for an understanding of the calling routine integrity checker, FIG. 1 does not show the typical components of many computers such as a keyboard, a mouse, a printer or other I/O devices, a display, etc. However, the computer 100 illustrated in FIG. 1 includes a hardware platform 102, an operating system 104, and an application platform 106 on which programs and malware may be executed. For ease of illustration and because they are not important for an understanding of the calling routine integrity checker, FIG. 1 is a highly simplified example that does not show many of the components that would be included in the computer 100, such as a CPU, memory, hard drive, etc.

As shown in FIG. 1, components of the computer 100 are layered with the hardware platform 102 on the bottom layer and the application platform 106 on the top layer. The layering of FIG. 1 illustrates that the calling routine integrity checker will typically be implemented in a hierarchical environment in which each layer of the computer 100 is dependent on systems in lower layers. More specifically, software that is not implemented by the operating system 104, executes within the restrictions of the application platform 106. As a result, application programs and malware are not able to directly access components of the operating system 104 or hardware platform 102. Instead, the operating system 104 provides services to software that is resident on the application platform 106 when access to components of the hardware platform 102 is needed. For example, when an application program needs the CPU to execute, a request is issued to the operating system 104, which performs all of the management tasks necessary to execute the application program on the hardware platform 102. In one embodiment, aspects of the calling routine integrity checker prevents malware from accessing services that are provided by the operating system 104 so that malicious functionality may not be executed on the computer 100.

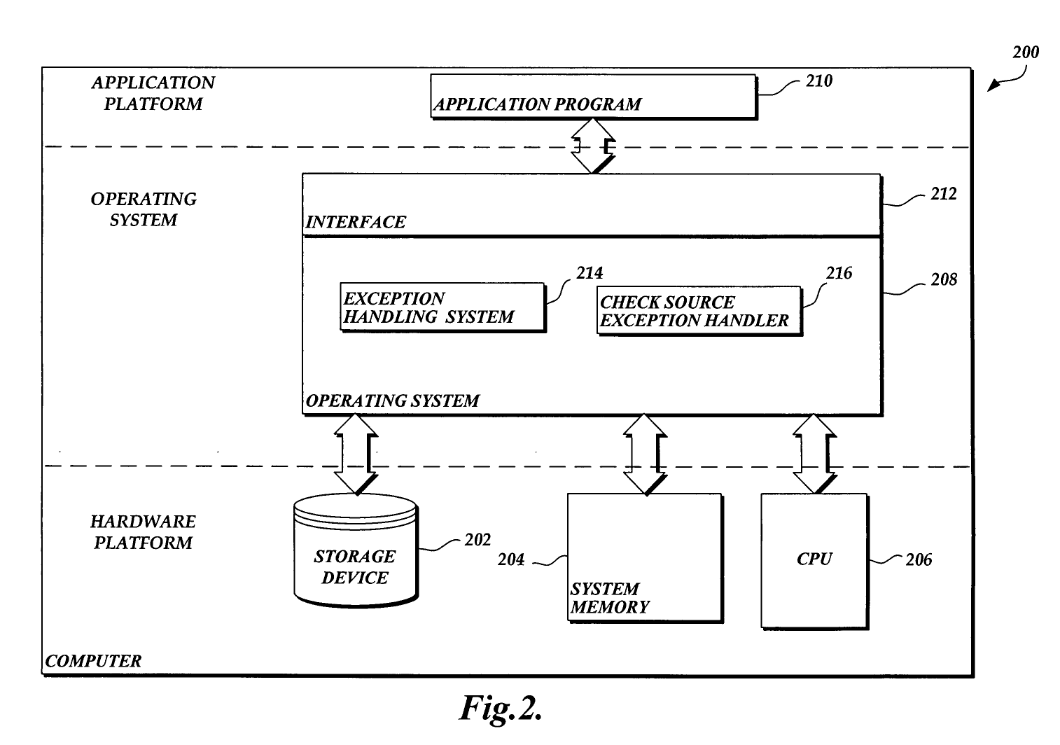

Now with reference to FIG. 2, an exemplary computer environment in which the calling routine integrity checker may be implemented will be described. However, those skilled in the art will recognize that the calling routine integrity checker may be implemented in other types of environments without departing from the scope of the claimed subject matter. Similar to the computer 100 illustrated in FIG. 1, the computer 200 illustrated in FIG. 2 may be any one of currently available or yet to be developed computing devices. Also, for ease of illustration and because it is not important for an understanding of the claimed subject matter, FIG. 2 does not show some of the typical components of many computers. However, as illustrated in FIG. 2, the computer 200 does include a storage device 202, a system memory 204, a Central Processing Unit (“CPU”) 206, an operating system 208, and an application program 210. Also, as illustrated in FIG. 2, the operating system 208 includes an interface 212, an exception handling system 214, and a check source exception handler 216. Moreover, FIG. 2 illustrates how components of the computer 200 maintain a hierarchical relationship in a way that is consistent with the description provided above with reference to FIG. 1.

As illustrated in FIG. 2, the computer 200 includes a storage device 202 that may consist of any available media that is accessible by the computer 200 and includes both volatile and nonvolatile media and removable and non-removable media. By way of example and not limitation, the storage device 202 may be volatile or nonvolatile, removable or nonremovable, implemented using any technology for storage of information such as, but not limited to a hard drive, CD-ROM, DVD, or other disk storage, magnetic cassettes, magnetic tape, magnetic disk storage, or any other media that can be used to store information and may be accessed by the computer 200 even through a computer network.

The computer 200 also includes system memory 204 that may be volatile or nonvolatile memory, such as Read Only Memory (“ROM”), Random Access Memory (“RAM”), or other storage mechanism that is readily accessible to the CPU 206 on the computer 200. Those skilled in the art and others will recognize that ROM and RAM typically contain data and/or program modules that are immediately accessible to and/or currently being operated on by the CPU 206. Moreover, the CPU 206 serves as the computational center of the computer 200 by supporting the execution of instructions. Also, those skilled in the art and others will recognize that malware typically carry out their malicious functionality when malware instructions are loaded into system memory 204 and then executed by the CPU 206.

The operating system 208 illustrated in FIG. 2 may be any type of operating system such as, but not limited to, a Microsoft® operating system, a UNIX® operating system, a Linux® operating system, and the like. As known to those skilled in the art and others, the operating system 208 controls the general operation of the computer 200 and is responsible for management of hardware and basic system operations as well as executing application programs. In this regard, the operating system 208 ensures that computer programs, such as application program 210, are able to use hardware resources on the computer 200. In this regard, the operating system 208 includes an interface 212 in the form of an Application Programming Interface (“API”) to one or more application program(s) installed on the computer 200. Those skilled in the art and others will recognize that APIs form a layer of software that defines the set of services offered by the operating system 208 to an application platform. For example, an application program written for Win 32 APIs, will run on all Win 32 operating systems. These systems are often targets of malware designers because their popularity offers a better opportunity for widespread dissemination of malware.

As illustrated in FIG. 2, the operating system 208 includes an exception handling system 214 which may be used to interrupt the flow program execution at runtime so that an exception handler may be executed. Those skilled in the art and others will recognize that when an exception raising condition is identified by the exception handling system 214, the instruction stream that is currently executing is interrupted and data associated with the exception raising condition is saved. Then the exception handling system 214 causes a branch to a predefined location in system memory 204 where an “exception handler” is stored. The exact exception handler invoked depends on which exception raising condition was identified by the exception handling system 214. Moreover, as the name suggests, the invoked exception handler performs actions in response to the exception raising condition. For example, the exception handling system 214 typically invokes an exception handler when the operating system 208 detects an error condition that may cause an application program to “crash.” In this example, the invoked exception handler may attempt to recover from the error so that program execution may continue.

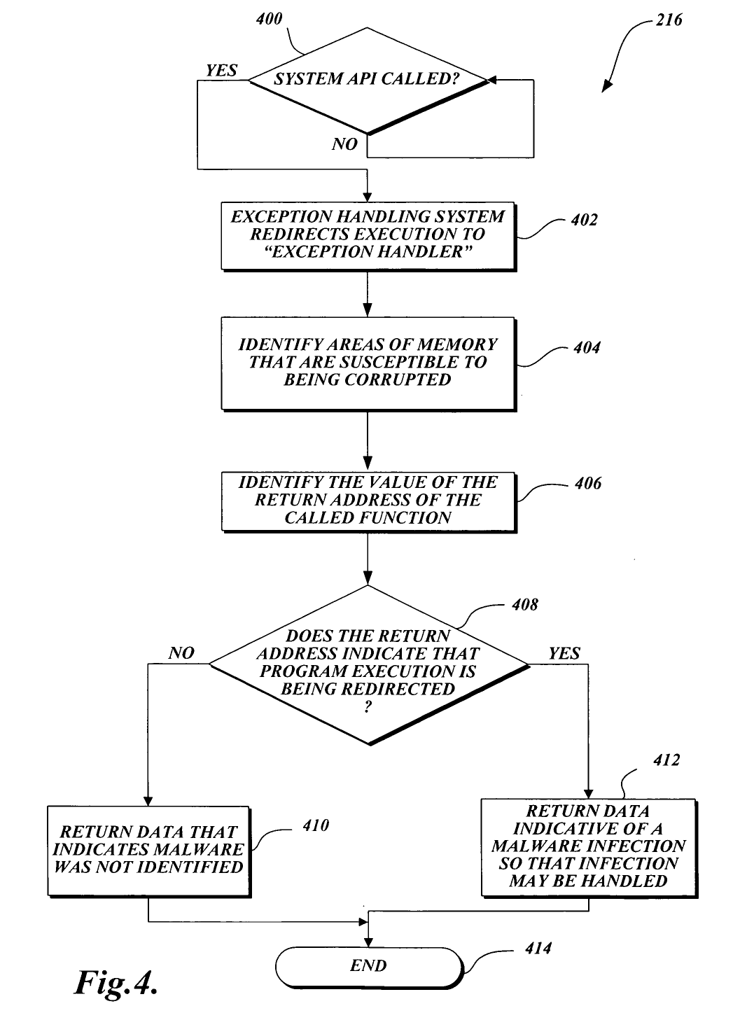

As illustrated in FIG. 2, the operating system 208 also includes a check source exception handler 216. Since functions and different embodiments of the check source exception handler 216 are described below with reference to FIG. 4, a detailed description of the handler 216 will not be provided here. However, generally described, the handler 216 implements logic that determines whether a request in the form of an API call issued to the operating system 208 originated from a location in system memory 204 that is susceptible to being corrupted by malware. In this regard, the exception handling system 214 invokes the exception handler 216 when a “system API” is called. Then, in one embodiment, the exception handler 216 identifies memory locations in system memory 204 where data obtained from an untrusted source is stored. The return address where program execution is scheduled to return after satisfaction of the API call is identified and compared to the identified areas of memory that store data obtained from an untrusted source. If program execution is being directed to an area of memory that stores data obtained from an untrusted source, the computer is identified as being infected.

In the embodiment of the computer 200 illustrated in FIG. 2, logic of the calling routine integrity checker is maintained in the operating system 208. For example, certain aspects of the calling routine integrity checker are implemented in the exception handler 216 (described below with reference to FIG. 4) which, in this exemplary embodiment, is depicted as being a component of the operating system 208. However, those skilled in the art and others will recognize that the computer architecture described with reference to FIG. 2 is exemplary and should not be construed as limiting. For example, the logic provided in the exception handler 216 may be implemented in other contexts without departing from the scope of the claimed subject matter. In this regard, the logic of the exception handler 216 may be implemented in other types of program modules such as drivers, filters, utilities, and the like. Generally stated, FIG. 2 is an exemplary depiction of one computer 200 in which the calling routine integrity checker may be implemented. Actual embodiments of the computer 200 will have additional components not illustrated in FIG. 2 or described in the accompanying text. Moreover, FIG. 2 shows one component architecture for preventing malware from accessing services provided by the operating system 208 but other component architectures are possible.

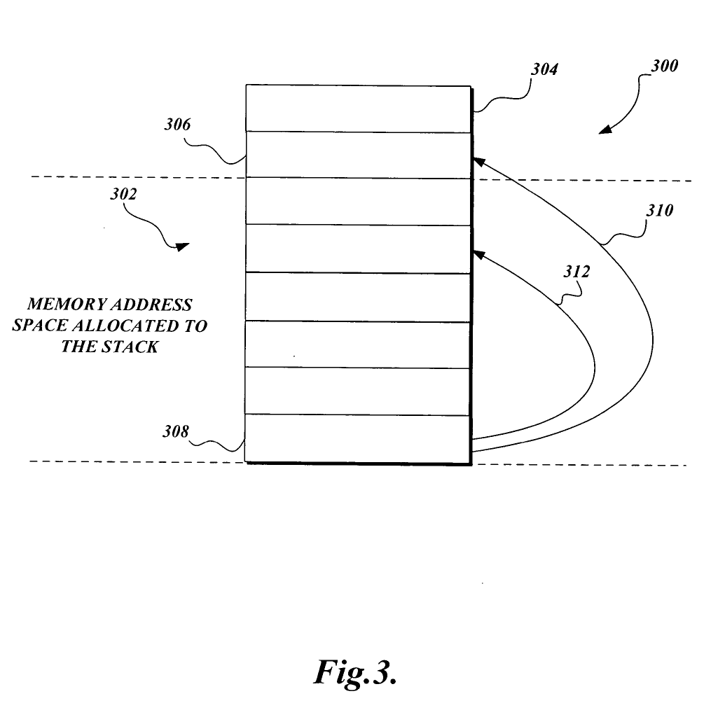

Now with reference to FIG. 3, a description of certain memory management functions of an operating system 208 and an exemplary technique implemented by some malware to corrupt memory allocated to a process will be described. As mentioned previously, in order to execute an application program, a component of the operating system 208 loads program data from a storage device 202 into system memory 204 where the data is readily accessible to the CPU 206. Moreover, in this regard, the operating system 208 allocates a virtual address space to the application program or “process” that is scheduled to be executed. The virtual address space is merely an abstraction of the physical memory address space (e.g., system memory 204) organized in a way that allows process data to be easily referenced and accessed. In some operating systems, the virtual address space is partitioned into segments, each of which is allocated contiguous areas of physical memory. For example, some operating systems organize process data into three segments including a (1) a text segment which contains the machine instructions of the process (2) a data segment for the initialized and uninitialized data portions of the process, and (3) a stack segment that maintains a run-time stack (hereinafter the “stack”) used to, among other things, execute function calls made to the operating system 208. As described in further detail below, some segments of a memory address space that are allocated to a process are more susceptible to being corrupted by malware then others.

FIG. 3 illustrates a memory address space 300 that is allocated to a process. The memory address space 300 includes a stack segment 302 consisting of a plurality of address locations; each of which stores a fixed amount of data. Moreover, the memory address space 300 includes a function call address location 304 and a function call return location 306 that are not in the memory address space allocated to the stack segment 302. Finally, the stack segment 302 includes an address location 308 that typically stores a return address pointer 310 that should refer to the function call return location 306.

The stack segment 302 illustrated in FIG. 3 is one type of data structure with attributes that are well-suited for executing API calls. Those skilled in the art and others will recognize that a function used by an operating system to satisfy requests is a segment of program code that is called as a subroutine, performs one or more tasks, and returns the flow of program execution back to the calling routine after the task(s) are complete. In some operating systems, when an API call is issued, a return address that identifies a location in memory where program execution should return after the function completes execution, is temporarily inserted or “pushed” onto the stack segment 302. In the context of FIG. 3, the first data item inserted on the stack segment 302 (at address location 308) will normally be the return address pointer 310. Moreover, the area of memory allocated to the stack segment 302 grows as arguments passed in an API call are added to the stack segment 302. As the function performs the requested task(s), the most recently added data items are removed or “popped” from the stack segment 302 until the return address pointer 310 is the only data item stored in the stack segment 302. Then, the value of the return address pointer 310 directs the flow of program execution back to the function call return location 306 where program execution of the calling routine may continue.

Unfortunately, the return address that is supposed to direct the flow of program execution back to a calling routine is sometimes susceptible to being overwritten or otherwise corrupted by malware. For example, as mentioned previously, arguments passed in an API call that originate from an untrusted source are stored in the stack segment 302. If a buffer allocated by an operating system is fixed in size and a mechanism does not exist for handling arguments that are larger than the allocated buffer, a malware author may generate input in an API call that overwrites the return address pointer 310. Moreover, the malware may overwrite the address location 308 with a pointer 312 designed to redirect the flow of program execution to data written to the stack segment 302 as a result of the API call.

Once the stack segment 302 has been corrupted in this type of “buffer overflow exploit,” malware instructions may attempt to perform a variety of malicious acts. For example, an instruction written to the stack segment 302 may issue an API call that, for example, directs the operating system to delete an important configuration database stored on a computer. Since, antivirus software may only perform a scan for malware “on access” when an application program is initially loaded in memory, this type of exploit has previously succeeded. Stated differently, in currently available systems, when an I/O-based API call or other potentially harmful operating system service is accessed, a check is not performed to determine whether the memory address space where the call originated has been corrupted.

In general terms describing one embodiment of the calling routine integrity checker, one or more operating system functions perform a check to determine whether program execution is scheduled to be redirected in a way that is characteristic of malware. More specifically, when an API call from the application platform is issued, a determination is made regarding whether the memory area used to satisfy the call has been corrupted. In one embodiment, the logic for performing the check is implemented in a callable “system API.” For example, an operating system function that allows applications programs to issue an API call for the purpose of performing I/O with an output device may call the “system API” described herein. When called, the system API “throws” an exception that interrupts the flow of program execution. Then, a determination is made regarding whether the API call issued from the application platform contains input that is configured to corrupt memory and redirect the normal flow of program execution.

It should be well understood that buffer overflow exploit described with reference to FIG. 3 should be construed as exemplary and not limiting. In this regard, those skilled in the art will recognize that malware may corrupt memory and redirect the flow of program execution using other known or yet to be discovered exploits. For example, in some operating systems, a data structure allocated to a process that is commonly known as a “heap” may be corrupted using techniques that are similar to those described above with reference to FIG. 3. Those skilled in the art will also recognize that the concepts described and claimed herein may be used to prevent any malware that corrupts a defined area of system memory, such as a stack or heap, from accessing the services provided by an operating system.

Now with reference to FIG. 4, an exemplary embodiment of a check source exception handler 216 illustrated in FIG. 2 will be described. As mentioned previously, in one embodiment, the exception handler 216 determines whether a request directed to an operating system is configured to redirect the flow of program execution in a way that is characteristic of malware. While the logic provided below is described as being implemented a program module commonly known as a “exception handler,” the logic may be implemented in other types of program modules without departing from the claimed subject matter. Moreover, as a preliminary matter, blocks 400 and 402 are performed before an “exception handler” is invoked, as that term is understood in the art. However, these steps are useful in illustrating aspects of the calling routine integrity checker that are described with reference to FIG. 4.

The method illustrated in FIG. 4 begins at decision block 400 where it remains idle until a call is made to the “system API” provided by the calling routine integrity checker. As mentioned previously, in one embodiment, logic for checking the integrity of a request made to the operating system may be called by a function that provides services to an application program. Stated differently, operating system functions that satisfy API calls may be configured to issue a call to the “system API” described herein. In response, the system API will return data to the calling function that indicates whether program execution is scheduled to be redirected in a way that is characteristic of malware.

At block 402, an exception handling system causes the exception handler 216 to be invoked. Since using an exception handling system to invoke an exception handler may be performed using techniques that are generally known in the art, further description of these techniques will not be provided here. However, it should be well understood that by using an exception handling system, the logic described below will be executed at runtime. As a result, malware that attempts to circumvent the protections provided by antivirus software, by corrupting or otherwise modifying the contents of memory, are unable to avoid being identified from the protective systems described herein. Moreover, the term exception handler as used herein is defined broadly to include any software system that interrupts program execution at runtime. As such, the integrity checking functions are described as being implemented in an exception handler. However, in alternative embodiments, these functions may be implemented in other types of software systems without departing from the scope of the claimed subject matter.

As illustrated in FIG. 4, at block 404, the exception handler 216 identifies the area(s) in the memory address space of the calling process that are susceptible to being corrupted by malware. As described above with reference to FIG. 3, the stack is an area of memory that is known to have the potential to be corrupted when an API call to an operating system is made. Thus, at least the area of memory allocated to the stack of the calling process is identified at block 404. Since the operating system is responsible for allocating memory to a process, identifying an area of memory that is susceptible to being corrupted by malware may be performed at block 404 by accessing data maintained in a operating system data structure.

At block 406, the value of the return address of the calling process that is requesting services of the operating system is identified. As described previously with reference to FIG. 3, when an API call to an operating system is made, the return address that identifies the memory location where program execution is scheduled to return after satisfaction of the API call is temporarily stored in the area of memory known as the stack. Similar to the description provided above with reference to block 404, since the operating system is responsible for allocating memory to a process, the value of return address may be identified at block 406 by accessing data that is maintained by an operating system.

At decision block 408, the exception handler 216 determines whether the value of the return address identified at block 406 will cause the flow in program execution to be redirected in a way that is characteristic of malware. As mentioned previously, arguments passed from an untrusted source in an API call are temporarily stored in a data structure known as the stack. This input may be configured to overwrite the return address on the stack and direct program execution to another memory location that stores data obtained from an on trusted source. Thus, if the return address has been overwritten and now refers or points to a memory another location on the stack, for example, the normal flow of program execution will be redirected in a way that is characteristic of malware. By contrast, if the stack has not been corrupted, the return address of the API call will refer to a memory location that is outside of the address space allocated to the stack. Thus, in one embodiment, the exception handler 216 performs a comparison, at block 408, of the return address (identified at block 406) with the memory address space allocated to a stack (identified at block 404). If the return address refers to a memory location that is within the bounds of the stack, the flow of program execution is scheduled to be redirected to a way that is characteristic of malware. In this instance, the exception handler 216 proceeds to block 412, described in further detail below. Conversely, if the return address does not refer to a location in memory used to store data that is obtained from an untrusted source, the exception handler 216 proceeds to block 410.

At block 410, the “system API” called at block 400 returns data to the calling function which indicates that malware was not identified. In this instance, the flow of program execution continues and the API call issued from the application platform is satisfied. Then the exception handler 216 proceeds to block 414 where it terminates.

At block 412, the “system API” called at block 400 returns data to the operating system which indicates that malware was identified. In this instance, the request made to the operating system from the application platform will not be satisfied. Instead, the flow in program execution will be interrupted so that the malware infection may be handled. In any event, data is returned to the operating system at block 412 which indicates that a malware infection exists so that the infection may be handled. Then the exception handler 216 proceeds to block 414 where it terminates.

Those skilled in the art and others will recognize that a malware infection may be handled in any number of different ways. For example, a cleaning routine may be available to remove the malware from the computer. Alternatively, a malware may be “quarantined” so that the malware is unable to implement malicious functionality on the computer. More specific to aspects of the present invention, the system API described above or other component of the operating system may be configured to perform additional actions when malware is identified as being resident on the computer. In one embodiment, a list is maintained by the operating system that identifies additional exception handlers which may be invoked when the type of malware described above is identified. These additional exception handlers provide logic for allowing program execution to safely continue even when malware is attempting to redirect the flow in program execution. For example, when a malware is identified that overwrites a return address stored in a stack, an exception handler may be called that identifies the correct return address where program execution should return. Then, the invoked exception handler causes program execution to continue at the correct return address. Moreover, those skilled in the art and others will recognize that this type of functionality may also be implemented in conjunction with the exception handler 216 described above with reference to FIG. 4 without departing from the scope of the claimed subject matter.

While illustrative embodiments have been illustrated and described, it will be appreciated that various changes can be made therein without departing from the spirit and scope of the invention.

The embodiments of the invention in which an exclusive property or privilege is: claimed are defined as follows:

1. In a computer that includes an operating system for managing execution of a program, a method of determining whether a request issued to the operating system was generated by malware, the method comprising:
(a) interrupting the flow in program execution when the request is issued to the operating system;
(b) identifying areas of memory allocated to the program that store data obtained from an untrusted source; and
(c) determining whether the flow in program execution is scheduled to be directed to an area of memory that stores data obtained from the untrusted source.

2. The method as recited in claim 1, further comprising:
(a) if the flow in program execution is scheduled to be directed to an area memory that stores data obtained from the untrusted source, determining that the request was issued by malware; and
(b) conversely, if the flow in program execution is not directed to an area of memory that stores data obtained from the untrusted source, determining that the request was not issued by malware and allowing the flow of program execution to continue.

3. The method as recited in claim 2, further comprising if the request was issued by malware causing program execution to continue by identifying the correct return address of a function and causing program execution to continue at the correct return address.

4. The method as recited in claim 1, wherein interrupting the flow in program execution includes causing an exception handling system to invoke an exception handler; and
wherein the exception handling system may be invoked by any function that provides services to the program by issuing a call to a system-based Application Programming Interface.

5. The method as recited in claim 1, wherein the request is an Application Program Interface call that is satisfied by a function exposed to an application platform by the operating system.

6. The method as recited in claim 1, wherein the interruption in the flow of program execution occurs at runtime while the program is in the process of being executed.

7. The method as recited in claim 1, wherein an area of memory that stores data obtained from the untrusted source is the area of memory allocated to the run-time stack.

8. The method as recited in claim 1, wherein an area of memory that stores data obtained from the untrusted source is the heap allocated to the program.

9. The method as recited in claim 1, wherein identifying areas of memory allocated to the program that stores data obtained from an untrusted source includes obtaining data maintained by the operating system for the purpose of performing memory management functions.

10. The method as recited in claim 1, wherein determining whether the flow in program execution is scheduled to be redirected to an area memory that stores data obtained from an untrusted source includes:
(a) identifying the return address where program execution is scheduled to return after the request is satisfied;
(b) comparing the return address to the area of memory allocated to the run-time stack of the program.

11. A software system for preventing a malware that is configured to overwrite data stored in computer memory for the purpose of altering the flow of program execution from accessing computer resources, the software system comprising:
(a) an operating system operative to manage resources of the computer and provide services when a request is issued by a program;
(b) an exception handling system operative to invoke the check source exception handler when an appropriate exception raising condition is identified; and
(c) a check source exception handler that is configured to determine whether the operating system received a call designed to modify the flow in program execution.

12. The software system as recited in claim 11, wherein the operating system includes an interface that defines the set of services available to the program; and
wherein the check source exception handler determines whether an application program interface call to the interface is configured to write data to the run-time stack allocated to the program so that the return address in the run-time stack is overwritten.

13. The software system as recited in claim 11, wherein the exception raising system causes the flow in program execution to be interrupted at runtime so that the check source exception handler may analyze data stored in memory during program execution.

14. The software system as recited in claim 13, wherein the appropriate exception raising condition is a system-based application programming interface call issued from a function that provides services to the program.

15. The software system as recited in claim 14 wherein the system-based application programming interface call may only be accessed by components of the operating system.

16. The software system as recited in claim 11, wherein the check source exception handler is further configured to return data to the calling function that indicates whether malware was identified; and
wherein if malware is identified the operating system is configured to prevent further execution of the program.

17. A computer-readable medium bearing computer-executable instructions which, when executed on a computer that includes an operating system for managing execution of a program, is configured to:
(a) interrupt the flow in program execution at runtime when a request to access computer resources is received by the operating system;
(b) identify areas of memory that store data passed to the operating system by the program; and
(c) determine whether data passed to the operating system by the program overwrite a memory location that directs the flow in program execution.

18. The computer-readable medium as recited in claim 17, wherein determining whether data passed to the operating system by the program overwrites a memory location that directs the flow in program execution includes:
(a) identifying the memory location that stores a return address where program execution is scheduled to return after the request is satisfied; and
(b) comparing the return address to the areas of memory that stores data passed to the operating system by the program.

19. The computer-readable medium as recited in claim 18, wherein if the return address references an area memory that stores data passed to the operating system by the program, determining that the program is infected with malware.

20. The computer-readable medium as recited in claim 19, wherein the area of memory that stores data passed to the operating system by the program is the run-time stack; and
wherein the return address is the first data item placed on the run-time stack when the request is received and the last item removed from the stack when the request is satisfied.
